(19) United States
(12) Patent Application Publication
(10) Pub. No.: US 2014/0340805 A1
(43) Pub. Date: Nov. 20, 2014

(54) TRANSFORMER MODULE

(71) Applicant: Nai-Chien CHANG, New Taipei City (TW)

(72) Inventor: Nai-Chien CHANG, New Taipei City (TW)

(21) Appl. No.: 14/271,453

(22) Filed: May 7, 2014

(30) Foreign Application Priority Data
May 14, 2013 (TW) 102208945

(51) Int. Cl. H02H 7/20; H01F 27/40

(52) U.S. Cl. CPC H02H 7/20; H01F 27/40
USPC 361/118

(57) ABSTRACT

A transformer module comprises a protection module, a transformer, a network IC module, and a body. The body has a containing space for encapsulating the protection module, the transformer and the network IC module. A plurality of upper terminals is set on a top side of the transformer, and a plurality of lower terminals is set on a bottom side of the transformer. The transformer is electrically connected with the protection module through the plurality of upper terminals, and is electrically connected with the network IC module through the plurality of lower terminals. A network connector can electrically connect with the protection module, the transformer and the network IC module of the transformer module in order when being connected with the transformer module through a computer mainboard. The present invention integrates all components needed by a network connector in a single body.

### BACKGROUND OF THE INVENTION

1. Field of the Invention

The present invention relates to a transformer, and in particular to a transformer module which integrates the transformer and other components needed by a network connector.

2. Description of Related Art

Generally, the nowadays electronic devices, especially computers are configured at least one network connector, such as RJ-45 connector for connecting to internet. User can connect the electronic device to the internet through a cable inserted to the network connector, and the computer can easily transmit data through the internet.

For using the network connector more safely, an ordinary computer is usually configured on an internal mainboard one or more components which are needed by the network connector, such as protection component, transformer, network IC, and so on.

A current problem is the above mentioned components will occupy a lot of spaces of the mainboard. However, to provide the ability of processing network related signal on the mainboard, and to provide protection for the computer from probably damage brought by the network connector (for example, noise, or surge generated by suffering lightning stroke), the amount of the above mentioned components can't be reduced.

As the result, how to save the space of the mainboard without reducing any electronic component is the main problem to be salve by the technical person in this field.

### SUMMARY OF THE INVENTION

The present invention is to provide a transformer module, which uses a transformer as a center core and integrates all components needed by a network connector in a single body. Further, the present invention has the convenience to set the single transformer module on a computer mainboard.

The transformer module includes a protection module, a transformer, a network IC module, and a body. The body has a containing space for encapsulating the protection module, the transformer and the network IC module. A plurality of upper terminals is set on a top side of the transformer, and a plurality of lower terminals is set on a bottom side of the transformer. The transformer is electrically connected with the protection module through the plurality of upper terminals, and is electrically connected with the network IC module through the plurality of lower terminals. A network connector can electrically connect with the protection module, the transformer and the network IC module of the transformer module in order when being connected with the transformer module through a computer mainboard.

For using a network connector safely, a computer mainboard usually sets many components thereon, such as protection component, transformer, network IC, which are needed by the network connector for safety. However, those components occupy the limited space of the mainboard. In comparison with related art, the present invention uses the transformer as a central core, and stacks other components on a top side and a lower side of the transformer, therefore, constitutes a single module by integrating all components in a single body.

The module of the present invention can be configured easily on the mainboard, and can save the limited space of the mainboard. In the other hand, the amount of the components configured on the mainboard needs not be reduced for saving the space of the mainboard, so the security of the network connector and the mainboard will be guaranteed.

### BRIEF DESCRIPTION OF THE DRAWINGS

FIG. 1 is a perspective view showing a usage of a transformer module of a first embodiment according to the present invention.

FIG. 2 is an exploded perspective view of the transformer module of the first embodiment according to the present invention.

FIG. 3 is a combination perspective view of the transformer module of the first embodiment according to the present invention.

FIG. 4 is a section view of the transformer module of the first embodiment according to the present invention.

FIG. 5 is a block diagram of the transformer module of the first embodiment according to the present invention.

FIG. 6 is a section view of the transformer module of a second embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

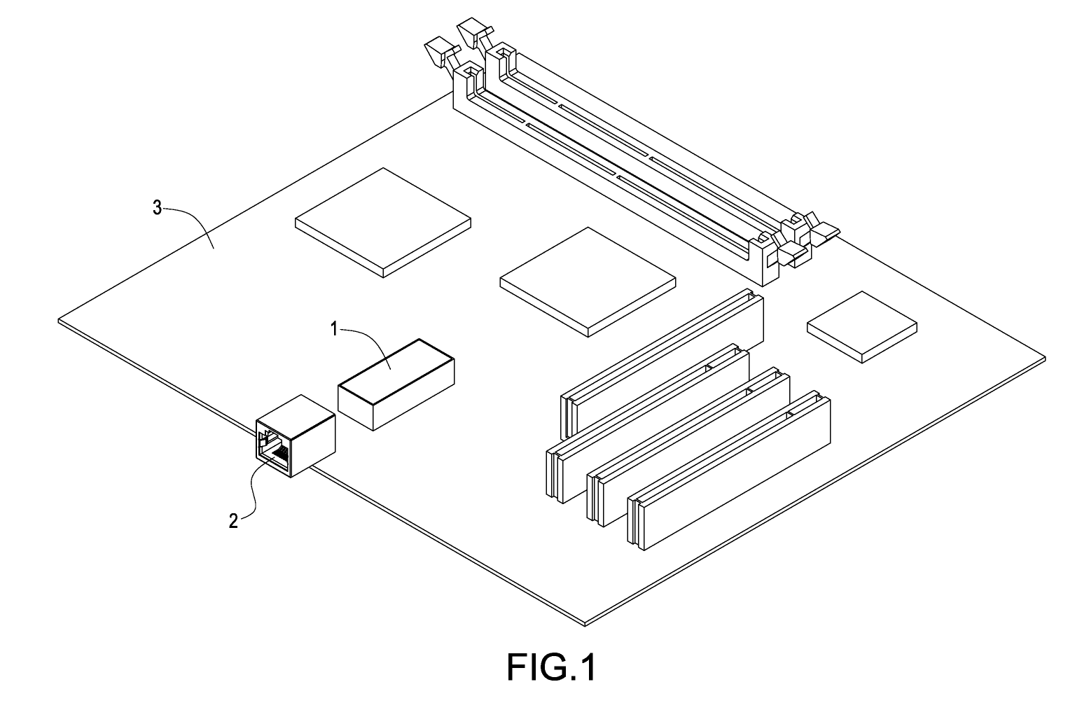

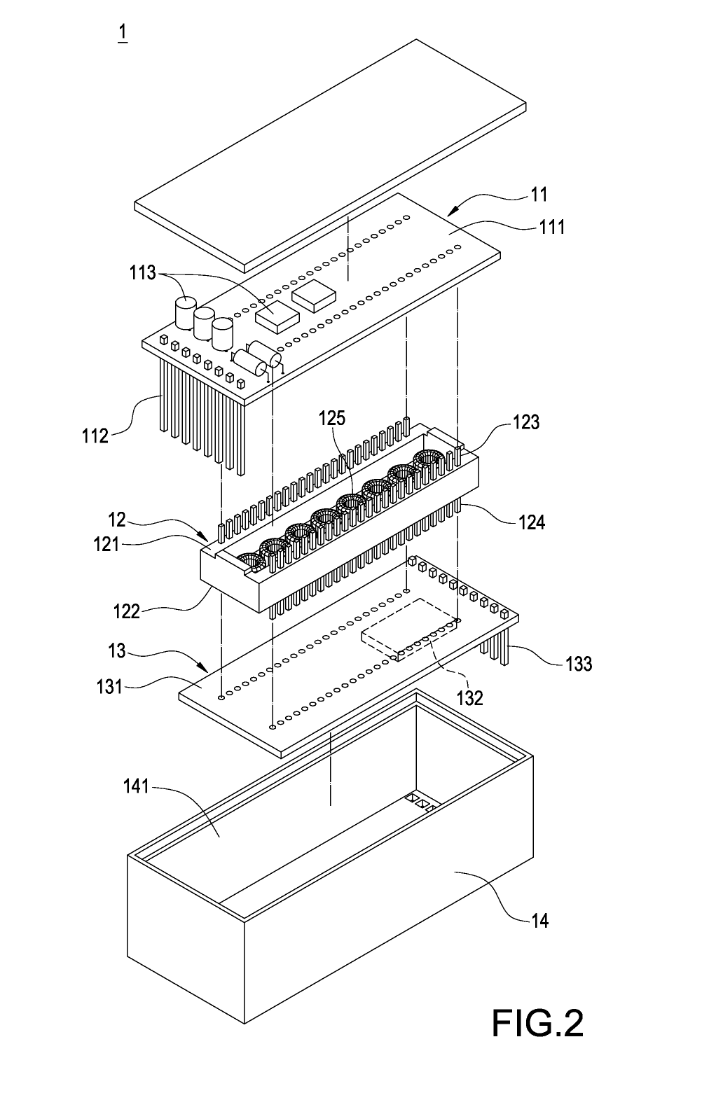

FIG. 1 is a perspective view showing a usage of a transformer module of a first embodiment according to the present invention. The present invention discloses a transformer module 1, the transformer module 1 integrates not only a transformer (as the transformer 12 shown in FIG. 2), but also other components which are needed by a network connector 2, such as a RJ-45 connector. Therefore, a mainboard 3 of a computer can safely connect and use the network connector 2 by way of configuring the transformer module 1 directly, and needs not to configure other additional components thereon. In this embodiment, the transform 12 can be, for example, a transformer integrated circuit (IC). Else, the transformer 12 can also be a modularized transformer which is constituted by multi-coils (as the coil 125 shown in FIG. 2), and the amount of the coil 125 can be four or eight, but not intended to limited the scope of the present invention.

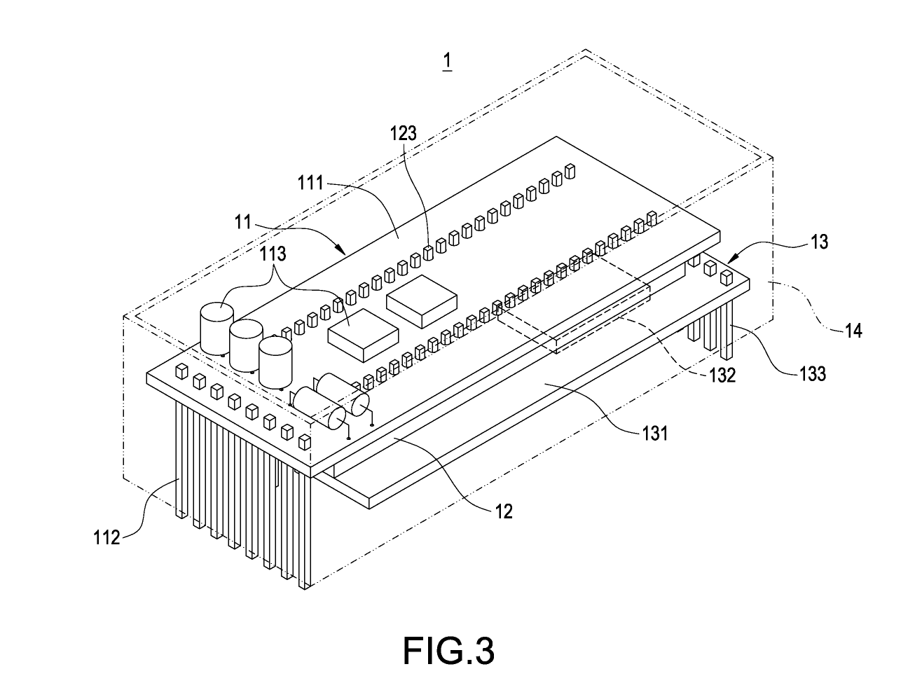

FIG. 2 is an exploded perspective view of the transformer module of the first embodiment according to the present invention. FIG. 3 is a combination perspective view of the transformer module of the first embodiment according to the present invention. As shown in FIG. 2 and FIG. 3, the transformer module 1 mainly comprises a protection module 11, the transformer 12, a network integrated circuit (IC) module 13, and a body 14. The body 14 has a containing space 141, and the containing space 141 encapsulates the protection module 11, the transformer 12 and the network IC module 13.

The main feature of the present invention is the transformer module 1 uses the transformer 12 as a central core, and the protection module 11, the transformer 12 and the network IC module 13 are stacked in vertical in the transformer module 1. In particularly, the protection module 11 is set at top layer of the transformer module 1, and the network IC module 13 is set at bottom layer of the transformer module 1, and the transformer 12 is set between the protection module 11 and the network IC module 13 in the transformer module 1. However, the above description is just the first embodiment, not intended to limit the scope of the present invention.

The transformer 12 has a top side 121 and a corresponding bottom side 122. The protection module 11 is set in parallel on the top side 121 of the transformer 12 and electrically connected with the transformer 12. The network IC module 13 is set in parallel on the bottom side 122 of the transformer 12 and electrically connected with the transformer 12. In particularly, a plurality of upper terminals 123 is set on the top side 121 of the transformer 12, and a plurality of lower terminals 124 is set on the bottom side 122 of the transformer 12. The transformer 12 is electrically connected with the protection module 11 through the plurality of upper terminals 123, and is electrically connected with the network IC module 13 through the plurality of lower terminals 124.

As shown in FIG. 2, the protection module 11 mainly comprises a first circuit board 111, a plurality of first connection terminals 112 and at least one protection component 113. The first circuit board 111 of the protection module 11 is set in parallel on the top side 121 of the transformer 12, and the protection module 11 is electrically connected with the plurality of upper terminals 123 of the transformer 12 through the first circuit board 111. The at least one protection component 113 is set on the first circuit board 111 and electrically connected to the transformer 12 through the first circuit board 111.

In this embodiment, the at least one protection component 113 can be, for example, a resistance, a capacitance, a transient voltage suppressor (TVS), or a gas discharge tube (GDT). Furthermore, the protection module 11 comprises electrical circuit set on the first circuit board 111 for constituting series circuit/parallel circuit of the protection components 113 on the first circuit board 111. However, the above description is just a preferred embodiment, not intended to limit the scope of the present invention.

One end of each of the plurality of first connection terminals 112 is electrically connected to the first circuit board 111 separately, and the other end of each of the plurality of first connection terminals 112 is extended downward and out of a bottom of the body 14. Therefore, the transformer module 1 can be electrically connected with the network connector 2 through the plurality of first connection terminals 112 (detailed described below).

The network IC module 13 mainly comprises a second circuit board 131, a network IC 132 and a plurality of second connection terminals 133. The second circuit board 131 of the network IC module 13 is set in parallel on the bottom side 122 of the transformer 12, and the network IC module 13 is electrically connected to the plurality of lower terminals 124 of the transformer 12 through the second circuit board 131. The network IC 132 is electrically connected to the second circuit board 131, and further electrically connected to the transformer 12 through the second circuit board 131.

In this embodiment, the network IC 132 is a local area network (LAN) IC, but not limited thereto. One end of each of the plurality of second connection terminals 133 is electrically connected to the second circuit board 131 separately, and the other end of each of the plurality of second connection terminals 133 is extended downward and out of the bottom of the body 14. In this embodiment, the transformer module 1 is connected with an external device through the plurality of first connection terminals 112 and the plurality of second connection terminals 133 simultaneously. As an example, an amount of the plurality of first connection terminals 112 is eight at least, and an amount of the plurality of second connection terminals 133 is ten at least. Accordingly, an amount of the plurality of upper terminals 123 of the transformer 12 is eight at least, and an amount of the plurality of lower terminals 124 is ten at least.

In this embodiment, the amount of the plurality of first connection terminals 112 and the plurality of upper terminals 123 are according to the amount of terminals (not shown) of the network connector 2. The amount of the plurality of second connection terminals 133 and the plurality of lower terminals 124 is according to the amount of output/input pins (not shown) of the network IC 132. However, above description is just a preferred embodiment, not intended to limit the scope of the present invention.

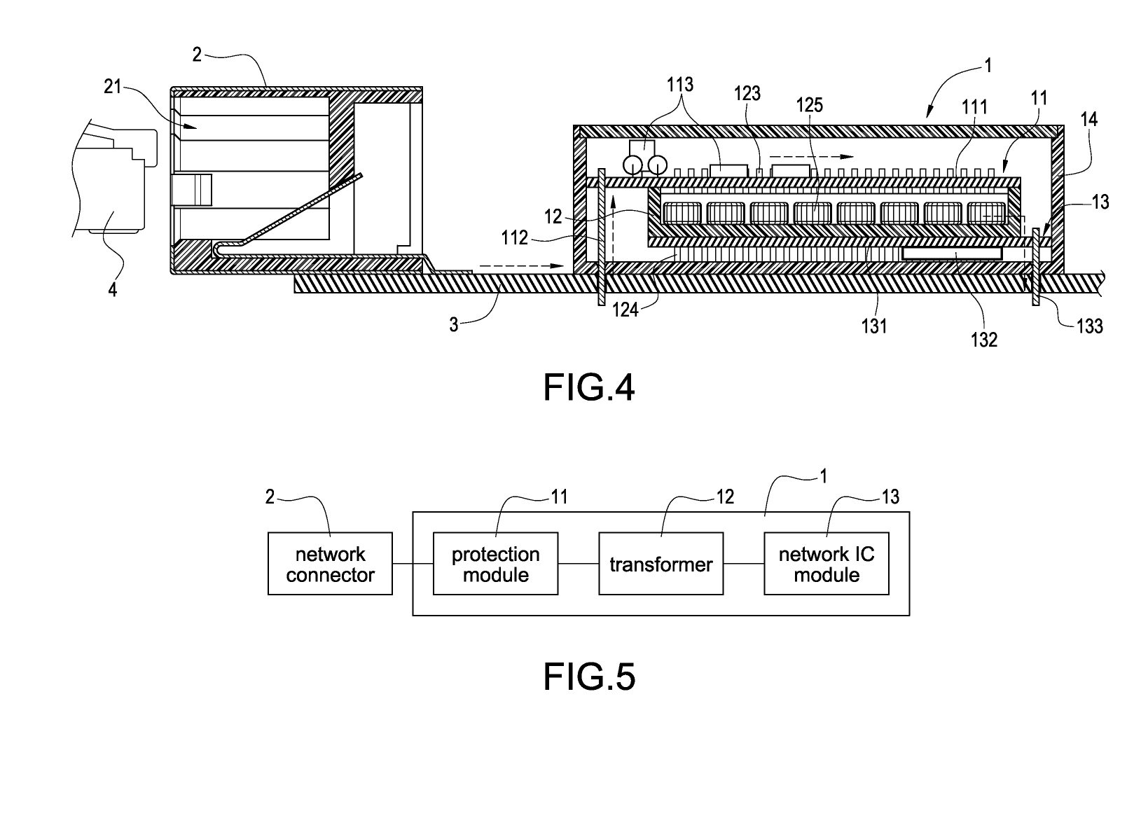

FIG. 4 is a section view of the transformer module of the first embodiment according to the present invention. FIG. 5 is a block diagram of the transformer module of the first embodiment according to the present invention. The transformer module 1 is electrically connected to the mainboard 3 by way of the plurality of first connection terminals 112 and the plurality of second connection terminals 133. The network connector 2 is electrically connected to the transformer module 1 by way of the mainboard 3, so as to connect with the protection module 11, the transformer 12 and the network IC module 13 of the transformer module 1 in order, and further connect with another components (not shown) configured on the mainboard 3.

As shown in FIG. 4, the network connector 2 is configured on the mainboard 3, and a connection port 21 of the network connector 2 can be inserted by one end of a cable 4. An electronic device (not shown) connected to the other end of the cable 4 can connect with the network connector 2 through the cable 4, and transmit electrical signal (such as network related signal) with the network connector 2. The network connector 2 transmits the received signal to the mainboard 3, and then mainboard 3 transmits the received signal to the protection module 11 of the transformer module 1 through the plurality of first connection terminals 112 for executing protective process by the at least one protection component 113. Therefore, the mainboard 3 can be avoided from the situation that being burned when the network connector 2 suffers external lightning stroke or surge.

The signal is then transmitted from the protection module 11 to the transformer 12 through the plurality of upper terminals 123, and the transformer 12 filters noise off the received signal. Then, the filtered signal is transmitted from the transformer 12 to the network IC module 13 through the plurality of lower terminals 124, and the network IC 132 of the network IC module 13 processes network related signal. The processed signal is then transmitted from the network IC module 13 to the mainboard 3 through the second connection terminals 133, and the other components (not shown) on the mainboard 3 can process and use the received signal. Following the above transmission order, the electronic device connected to the cable 4 can transmit the network related signal to a computer which has the mainboard 3, and the computer can process and use the received network related signal, so as to connect with the internet.

On the contrary, the above transmission order is reversed when signal is transmitted externally from the mainboard 3. In particularly, the signal is first transmitted from the mainboard 3 to the network IC module 13 through the plurality of second connection terminals 133, then transmitted from the network IC module 13 to the transformer 12 through the plurality of lower terminals 124, and then transmitted from the transformer 12 to the protection module 11 through the plurality of upper terminals 123, and then transmitted from the protection module 11 to the mainboard 3 through the plurality of first connection terminals 112. Therefore, the mainboard 3 can finally transmit the signal to the network connector 2.

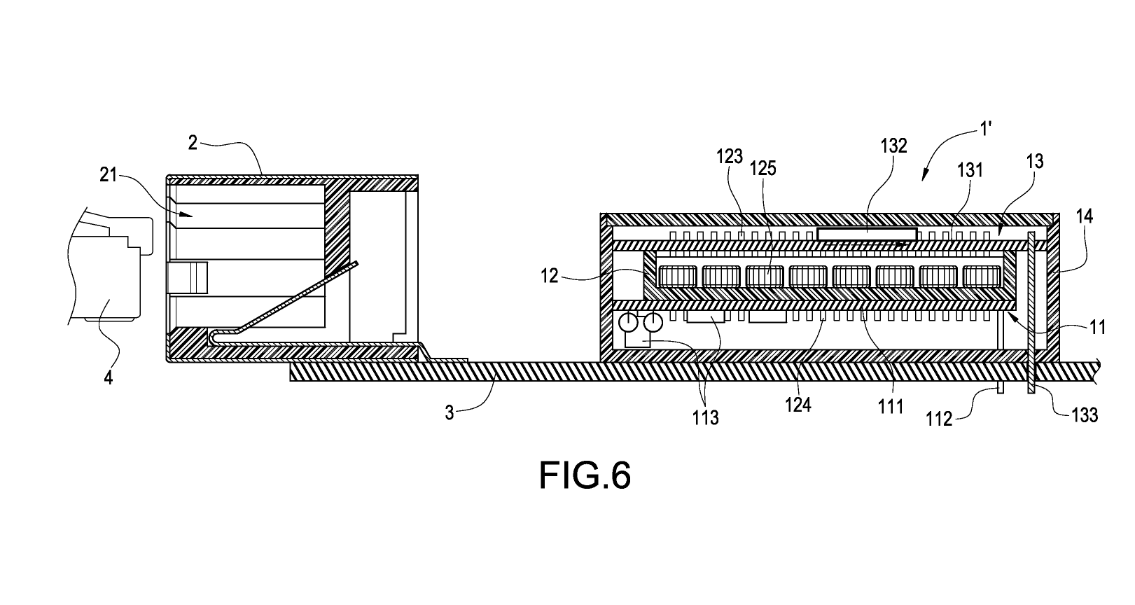

FIG. 6 is a section view of the transformer module of a second embodiment according to the present invention. This embodiment discloses another transformer module 1′. The difference between the transformer module l′ and the above disclosed transformer module 1 is the network IC module 13 of the transformer module l′ is configured on the top side 121 of the transformer 12, and the protection module 11 of the transformer module l′ is configured on the bottom side 122 of the transformer 12.

As shown in FIG. 6, the second circuit board 131 of the network IC module 13 of the transformer module l′ is set in parallel on the top side 121 of the transformer 12, and the network IC module 13 is electrically connected to the plurality of upper terminals 123 of top side 121 of the transformer 12 through the second circuit board 131. The first circuit board 111 of the protection module 11 of the transformer module l′ is set in parallel on the bottom side 122 of the transformer 12, and the protection module 11 is electrically connected to the lower terminals 124 of the bottom side 122 of the transformer 12 through the first circuit board 111. As the same as the transformer module 1, the transformer module l′ in this embodiment also has the body 14, and the body 14 encapsulates the network IC module 13, the transformer 12, and the protection module 11 of the transformer module 1′.

Although the stacking order of the network IC module 13, the transformer 12 and the protection module 11 of the transformer module l′ in this embodiment is different from that of the transformer module 1 mentioned above, however, the signal transmission order of the transformer module l′ in this embodiment is as the same as the signal transmission order of the transformer module 1.

In particularly, when the network connector 2 receives the signal from the cable 4, it transmits the received signal to the mainboard 3, and the mainboard 3 transmits the received signal to the protection module 11 on bottom layer of transformer module l′ through the plurality of first connection terminals 112 for executing protective process by the protection component 113. The signal then is transmitted from the protective module 11 to the transformer 12 through the plurality of lower terminals 124 for noise filtering. The filtered signal is then transmitted from the transformer 12 to the network IC module 13 through the plurality of upper terminals 123, and the network IC 132 of the network IC module 13 processes network related signal. The processed signal is then transmitted from the network IC module 13 to the mainboard 3 through the second connection terminals 133, and the other component (not shown) on the mainboard 3 can finally process and use the network related signal.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A transformer module, comprising:
a transformer having a top side and a corresponding bottom side;
a protection module, configured in parallel on the top side of the transformer and electrically connected with the transformer;
a network IC module, configured in parallel on the bottom side of the transformer and electrically connected with the transformer; and
a body having a containing space, the containing space encapsulating the transformer, the protection module, and the network IC module.

2. The transformer module according to claim 1, wherein the transformer comprises a plurality of upper terminals set on the top side, and comprises a plurality of lower terminals set on the bottom side, wherein the transformer is electrically connected to the protection module through the plurality of upper terminals, and is electrically connected to the network IC module through the plurality of bottom terminals.

3. The transformer module according to claim 2, wherein the transformer is a transformer IC or a modularized transformer constituted by multiple coils.

4. The transformer module according to claim 3, wherein the protection module comprises a first circuit board, a plurality of first connection terminals, and at least one protection component, wherein the first circuit board is electrically connected to the plurality of upper terminals of the transformer, the at least one protection component is electrically connected to the first circuit board, one end of each of the plurality of first connection terminals is electrically connected to the first circuit board, and the other end of each of the plurality of first connection terminals is extended downward and out of the body.

5. The transformer module according to claim 4, wherein the at least one protection component is a resistance, a capacitance, a transient voltage suppressor (TVS), or a gas discharge tube (GDT).

6. The transformer module according to claim 4, wherein the network IC module comprises a second circuit board, a plurality of second connection terminals, and a network IC, wherein the second circuit board is electrically connected to the plurality of lower terminals of the transformer, the network IC is electrically connected to the second circuit board, one end of each of the plurality of second connection terminals is electrically connected to the second circuit board, and the other end of each of the plurality of second connection terminals is extended downward and out of the body.

7. The transformer module according to claim 6, wherein an amount of the plurality of first connection terminals is at least eight, an amount of the plurality of second connection terminals is at least ten, an amount of the plurality of upper terminals is at least eight, and an amount of the plurality of lower terminals is at least ten.

8. A transformer module, comprising:
a transformer having a top side set a plurality of upper terminals thereon and a corresponding bottom side set a plurality of lower terminals thereon;
a network IC module, configured in parallel on the top side of the transformer and electrically connected with the transformer;
a protection module, configured in parallel on the bottom side of the transformer and electrically connected with the transformer;
a body having a containing space, the containing space encapsulating the transformer, the protection module and the network IC module;
wherein the transformer is a transformer IC or a modularized transformer constituted by multiple coils, and the transformer electrically connected to the network IC module through the plurality of upper terminals, and electrically connected to the protection module through the plurality of lower terminals.

9. The transformer module according to claim 8, wherein the protection module comprises a first circuit board, a plurality of first connection terminals, and at least protection component, wherein the first circuit board is electrically connected to the plurality of lower terminals of the transformer, the at least one protection component is electrically connected to the first circuit board, one end of each of the plurality of first connection terminals is electrically connected to the first circuit board, and the other end of each of the plurality of first connection terminals is extended downward and out of the body, wherein the at least one protection component is a resistance, a capacitance, a transient voltage suppressor (TVS), or a gas discharge tube (GDT).

10. The transformer module according to claim 9, wherein the network IC module comprises a second circuit board, a plurality of second connection terminals, and a network IC, wherein the second circuit board is electrically connected to the plurality of upper terminals of the transformer, the network IC is electrically connected to the second circuit board, one end of each of the plurality of second connection terminals is electrically connected to the second circuit board, and the other end of each of the plurality of second connection terminals is extended downward and out of the body.
